(19) United States
(12) Patent Application Publication
(10) Pub. No.: US 2009/0079685 A1
(43) Pub. Date: Mar. 26, 2009

(54) Liquid crystal display device, method for driving liquid crystal display device, and electronic apparatus

(75) Inventor: Eiji Sakai, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/230,893

(22) Filed: Sep. 8, 2008

(30) Foreign Application Priority Data
Sep. 21, 2007 (JP) 2007-244881

(51) Int. Cl. G09G 3/36

(52) U.S. Cl. 345/94; 345/87

(57) ABSTRACT

Disclosed herein is a liquid crystal display device that carries out image displaying through application of a voltage dependent upon an image to a liquid crystal in units of a certain period, wherein in the case of applying an overdrive voltage higher than a voltage for displaying of the image to the liquid crystal before application of the voltage, an application period of the overdrive voltage is set shorter than the certain period.

### CROSS REFERENCES TO RELATED APPLICATIONS

The present invention contains subject matter related to Japanese Patent Application JP 2007-244881 filed in the Japan Patent Office on Sep. 21, 2007, the entire contents of which being incorporated herein by reference.

### BACKGROUND OF THE INVENTION

1. Field of the Invention

The present invention relates to a liquid crystal display device that allows the high-speed response of a liquid crystal through application of an overdrive voltage, a method for driving a liquid crystal display device, and electronic apparatus.

2. Description of the Related Art

In overdrive driving of a liquid crystal display device in a related art, as shown in drawings, the overdrive voltage is controlled depending on the achieving luminance and the luminance level of the previous frame in order to suppress the overshoot and undershoot of the luminance (refer to e.g. Japanese Patent No. 3346843).

If suppression of the overshoot and undershoot through adjustment of the application voltage is intended in such a related art, the acceleration effect by the voltage is not so expected in the case in which the voltage level difference is small, such as the case of response between intermediate grayscales or response to a low grayscale, because the overdrive voltage determines the effective voltage in this case. Specifically, in the case of transition from low grayscale luminance to low grayscale luminance, it is impossible to apply a high overdrive voltage, which causes the limit to enhancement in the speed of luminance transition between intermediate grayscales.

### SUMMARY OF THE INVENTION

The present invention is made in order to address such a problem. According to an embodiment of the present invention, there is provided a liquid crystal display device that carries out image displaying through application of a voltage dependent upon an image to a liquid crystal in units of a certain period. In this liquid crystal display device, in the case of applying an overdrive voltage higher than a voltage for displaying of the image to the liquid crystal before application of the voltage, the application period of the overdrive voltage is set shorter than the certain period.

By thus adjusting the pulse width for the application of the overdrive voltage, the effective voltage can be adjusted in such a way that the acceleration voltage necessary at the time of the response of liquid crystal molecules is ensured, which allows the response of the liquid crystal molecules at higher speed.

In this embodiment of the present invention, in addition to the above-described configuration, the application period of the overdrive voltage may be adjusted depending on the grayscale level of the image, or the application period and the voltage value of the overdrive voltage may be adjusted depending on the grayscale level of the image.

Furthermore, in this embodiment of the present invention, a first overdrive voltage and a second overdrive voltage that have different polarities may be used as the overdrive voltage.

By thus adjusting the application period and the voltage value of the overdrive voltage, the effective voltage can be adjusted in such a way that the acceleration voltage necessary at the time of the response of liquid crystal molecules is ensured, which allows the response of the liquid crystal molecules at higher speed.

According to another embodiment of the present invention, there is provided a method for driving a liquid crystal display device that carries out image displaying through application of a voltage dependent upon an image to a liquid crystal in units of a certain period. The method includes the step of, in the case of applying an overdrive voltage higher than a voltage for displaying of the image to the liquid crystal before application of the voltage, applying the overdrive voltage for an application period shorter than the certain period.

By thus adjusting the pulse width for the application of the overdrive voltage, the effective voltage can be adjusted in such a way that the acceleration voltage necessary at the time of the response of liquid crystal molecules is ensured, which allows the response of the liquid crystal molecules at higher speed.

According to yet another embodiment of the present invention, there is provided electronic apparatus including a liquid crystal display device that carries out image displaying through application of a voltage dependent upon an image to a liquid crystal in units of a certain period. In this electronic apparatus, in the case of applying an overdrive voltage higher than a voltage for displaying of the image by the liquid crystal display device to the liquid crystal before application of the voltage, the application period of the overdrive voltage is set shorter than the certain period.

By thus adjusting the pulse width for the application of the overdrive voltage to the liquid crystal in the liquid crystal display device, the effective voltage can be adjusted in such a way that the acceleration voltage necessary at the time of the response of liquid crystal molecules is ensured, which allows the response of the liquid crystal molecules at higher speed.

Thus, according to the embodiments of the present invention, the response speed of the liquid crystal can be sufficiently enhanced even in the case in which the voltage level difference is small, such as the case of response between intermediate grayscales.

### BRIEF DESCRIPTION OF THE DRAWINGS

FIG. 1 is a block diagram for explaining the configuration of a liquid crystal display device according to an embodiment of the present invention;

FIG. 2 is a diagram for explaining a specific waveform of overdrive driving;

FIG. 3 is a diagram for explaining a pulse in related-art overdrive driving;

FIG. 4 is another diagram for explaining a pulse in related-art overdrive driving;

FIG. 5 is a diagram for explaining a pulse in overdrive driving of the embodiment;

FIG. 6 is a diagram showing the relationship between a voltage-transmittance characteristic and response speed;

FIG. 7 is a diagram showing a response waveform when an overdrive voltage is applied without adjustment;

FIG. 8 is a diagram showing a response waveform when an overdrive voltage is applied with adjustment;

FIG. 9 is a diagram showing a response waveform when an overdrive voltage of the embodiment (Working example 1) is applied;

FIG. 10 is a diagram showing a response waveform when an overdrive voltage of the embodiment (Working example 2) is applied;

FIG. 11 is a diagram collectively showing effects of improvement in response speed in experimental examples;

FIG. 12 is a schematic plan view for explaining a module shape;

FIG. 13 is a perspective view showing a television to which the embodiment is applied;

FIGS. 14A and 14B are perspective views showing a digital camera to which the embodiment is applied: FIG. 14A is a front-side view and FIG. 14B is a rear-side view;

FIG. 15 is a perspective view showing a notebook personal computer to which the embodiment is applied;

FIG. 16 is a perspective view showing a video camera to which the embodiment is applied; and

FIGS. 17A to 17G are diagrams showing a cellular phone as portable terminal apparatus to which the embodiment is applied: FIGS. 17A and 17B are a front view and side view, respectively, of the opened state, and FIGS. 17C to 17G are a front view, left-side view, right-side view, top view, and bottom view, respectively, of the closed state.

### DETAILED DESCRIPTION OF THE PREFERRED EMBODIMENT

An embodiment of the present invention will be described below based on the drawings.

### <Configuration of Liquid Crystal Display Device>

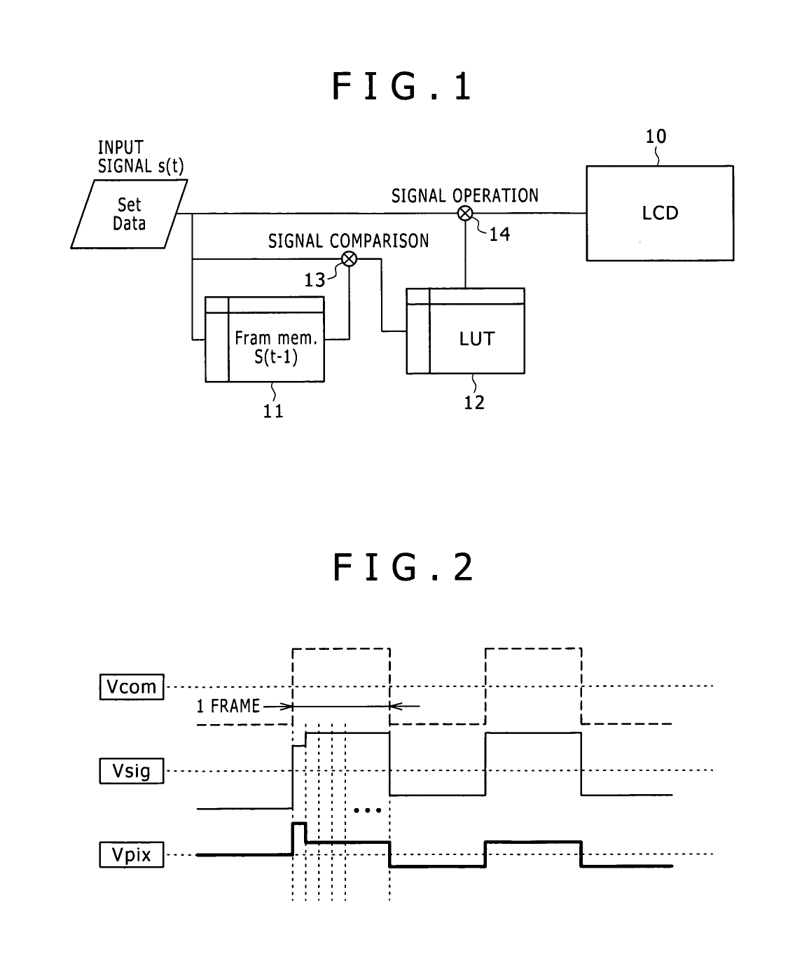

FIG. 1 is a block diagram for explaining the configuration of a liquid crystal display device according to the present embodiment. Specifically, in the liquid crystal display device of the present embodiment, a predetermined voltage is applied to a liquid crystal display (LCD) 10 as a panel including a liquid crystal in units of a certain period (e.g. one-frame period or one-field period), to thereby display an image. In particular, before the application of the voltage for the image displaying, an overdrive voltage higher than this voltage is applied to the LCD 10, to thereby carry out driving for obtaining high-speed response.

Besides this LCD 10, the liquid crystal display device includes a frame memory 11 that stores an image signal, and a look up table (LUT) 12 consulted for setting the signal (voltage) for liquid crystal driving. In addition, the liquid crystal display device includes a signal comparator 13 and a signal operation unit 14 for arithmetic operation of the voltage that is to be supplied to the LCD 10.

A feature of the liquid crystal display device of the present embodiment is as follows. Specifically, for realization of the high-speed response of the liquid crystal through application of the overdrive voltage, the overdrive voltage is applied for an application period shorter than the certain period of image displaying in order to allow adjustment of the effective voltage while ensuring the acceleration voltage necessary at the time of the response of the liquid crystal molecules. In the present embodiment, for easy understanding, the one-frame period is employed as the certain period, during which the voltage for image displaying is applied to the liquid crystal.

### <Overdrive Driving>

The flow of a signal in the overdrive driving in the liquid crystal display device shown in FIG. 1 will be described below. Initially, upon transmission of an image signal S(t−1) from the signal source, the image signal S(t−1) is stored in the frame memory 11. Subsequently, an image signal S(t) of the next frame is transmitted from the signal source. The image signals S(t−1) and S(t) are compared with each other by the signal comparator 13, and the proper overdrive pulse width is set through reference to the LUT 12. Subsequently, the signal operation unit 14 superimposes the overdrive pulse specified in the LUT 12 on the image signal S(t), and the LCD 10 is driven.

Specifically, the pulse widths of the overdrive voltage corresponding to the differences between frames of the image signal are registered in the LUT 12 in advance. The difference between the image signal S(t−1) of a predetermined frame stored in the frame memory 11 and the image signal S(t) of the next frame as an input signal is calculated by the signal comparator 13, and the pulse width of the overdrive voltage corresponding to this difference is set through reference to the LUT 12. Subsequently, the set overdrive voltage is superimposed on the image signal S(t) by the signal operation unit 14, so that the LCD 10 is driven by the resulting signal.

### <Specific Drive Method>

With reference to FIG. 2, a specific waveform of the overdrive driving will be described below by taking Vcom (common potential) inversion driving as an example. As the signal application method, the above-described image signals S(t−1) and S(t) are compared with each other, and the overdrive voltage having the pulse width set through reference to the LUT is applied by using a partial time in the first one-frame period.

In the example shown in FIG. 2, a signal Vsig arising from superposition of an overdrive voltage Vpix set through reference to the LUT on the image signal S(t) is applied to the LCD. The pulse width of the overdrive voltage to be superimposed on the image signal may be controlled in an analogous manner. Alternatively, the overdrive voltage application can be realized also by properly dividing the one-frame period into e.g. 64 stages or 256 stages in a digital manner in advance and applying the overdrive voltage with the pulse width set through reference to the LUT.

In the example shown in FIG. 2, the overdrive pulse is applied with the same phase as that of the frame to which the overdrive is to be applied. However, the same advantageous effect can be achieved also with the reversed phase. Furthermore, it is also possible to apply the overdrive pulse in such a manner as to divide the overdrive pulse into two stages of different polarities. Also in this case, the overdrive voltage application can be realized by applying the overdrive pulses set through reference to the LUT in two stages within the one-frame period in which the overdrive is to be applied similarly to the above-described case.

Moreover, in the above-described example, a one-frame period is divided and the overdrive pulse is applied in the one-frame period. Alternatively, the overdrive pulse may be applied in the period between the frame periods (in the vertical blanking period).

<Comparison with Related Art>

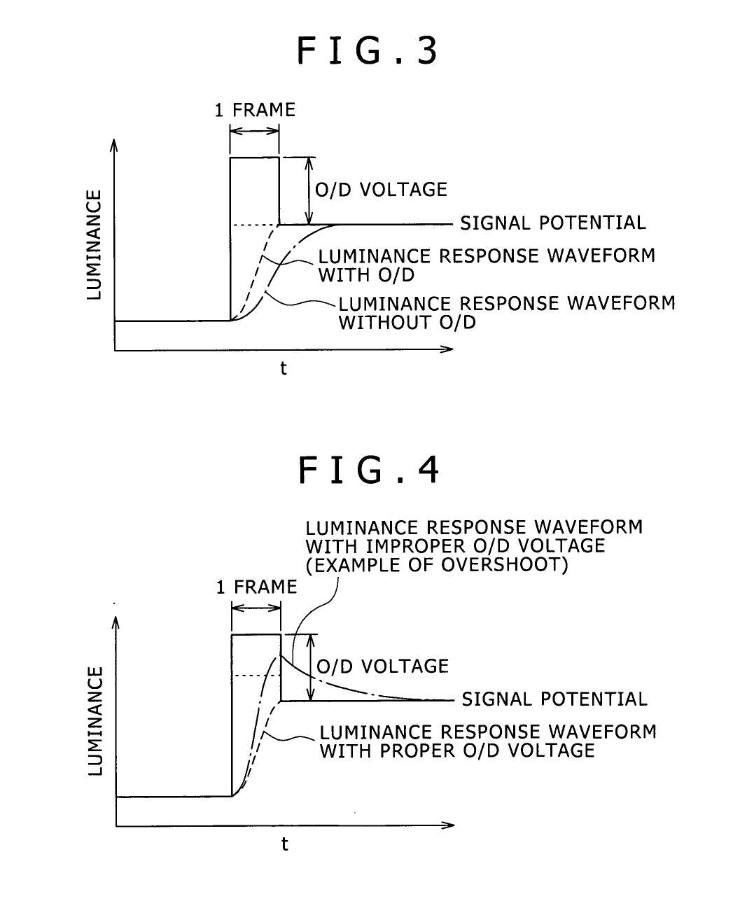

The overdrive driving of the present embodiment will be described below based on comparison with a related art. FIGS. 3 and 4 are diagrams for explaining pulses in related-art overdrive driving. In the related-art overdrive driving, as shown in FIG. 3, the value of the overdrive voltage is controlled depending on the achieving luminance and the luminance level of the previous frame in order to suppress the overshoot and undershoot of the luminance.

However, as shown in FIG. 4, if an overdrive voltage higher than the proper overdrive voltage is applied in the case of e.g. transition from low grayscale luminance to low grayscale luminance, luminance overshoot occurs, which causes a problem in the response of luminance transition between intermediate grayscales.

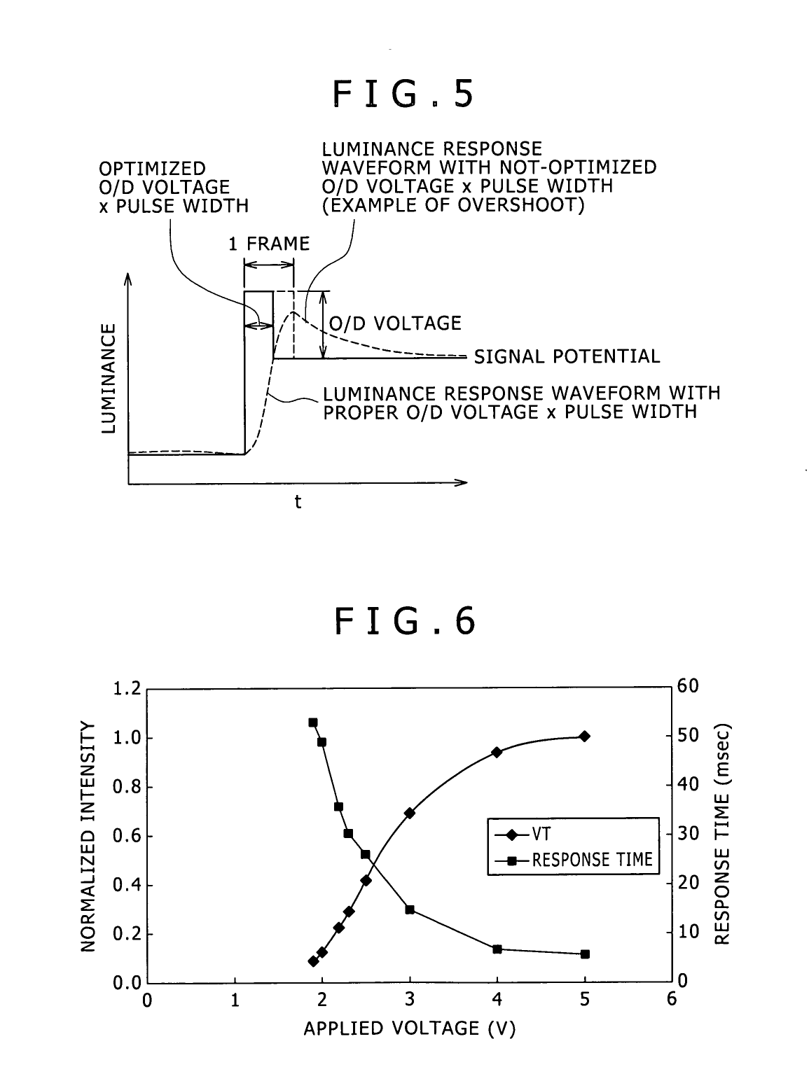

FIG. 5 is a diagram for explaining a pulse in the overdrive driving of the present embodiment. As shown in this diagram, in the present embodiment, a method of suppressing overshoot and undershoot through adjustment of the overdrive voltage is not employed, but the overdrive voltage is kept at e.g. a constant value and the application period of the overdrive voltage is adjusted to thereby suppress overshoot and undershoot. This can further improve the response speed on the lower-grayscale side particularly. This is because the response of liquid crystal molecules is controlled based on both the acceleration by the voltage at the time of the application thereof and the action of the molecules for stabilization with respect to the effective voltage.

Specifically, if suppression of overshoot and undershoot through adjustment of the application voltage is intended like the related-art overdrive driving, the acceleration effect by the voltage is not so expected in the case in which the voltage level difference is small, such as the case of response between intermediate grayscales or response to a low grayscale, because the overdrive voltage determines the effective voltage in this case. This causes the limit to improvement in the response speed.

On the other hand, in the driving in which the pulse width of the overdrive voltage is adjusted like the present embodiment, overshoot and undershoot can be suppressed by shortening the pulse width even when the value of the overdrive voltage is high. Furthermore, the effective voltage can be adjusted in such a way that the acceleration voltage necessary at the time of the response of liquid crystal molecules is ensured, which allows the response of the liquid crystal molecules at higher speed.

In addition, in the present embodiment, besides the adjustment of the pulse width of the overdrive voltage dependent upon the grayscale level of an image, the voltage value of the overdrive voltage can also be adjusted depending on the grayscale level. That is, it is also possible to carry out adjustment based on both the pulse width and the voltage value.

### <Experimental Examples>

Experimental examples for confirmation of the effect of the overdrive driving of the present embodiment will be described below. In the examples, experiments were carried out by use of liquid crystal cells each obtained by performing anti-parallel rubbing treatment for vertical alignment layers and enclosing a liquid crystal material of a negative dielectric into a simple liquid crystal cell.

FIG. 6 shows the voltage-transmittance characteristic and the response speed (0 V to transition voltage: the time of transition from a transmittance of 10 to a transmittance of 90) of this liquid crystal cell. As shown in FIG. 6, as the application voltage decreases and the transmittance decreases, the response speed becomes low drastically.

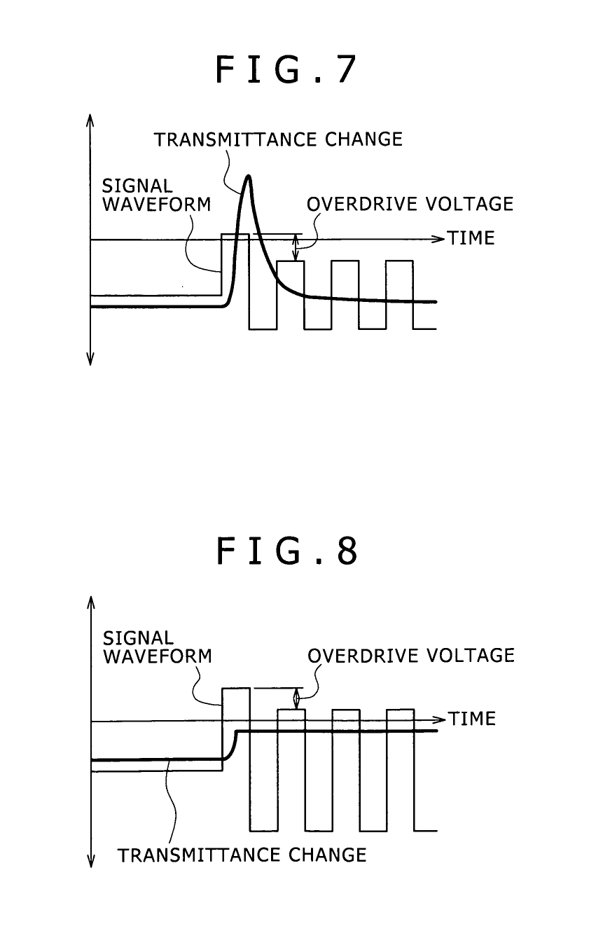

Initially, the response waveform when an overdrive voltage is applied without any particular adjustment is shown in FIG. 7. In FIG. 7, as described above, the overshoot phenomenon, in which the transmittance becomes high temporarily, is found.

In the next experimental example, the level (voltage value) of the overdrive voltage was adjusted. Specifically, the overdrive voltage was adjusted to 2.5 V with respect to the final achieving voltage of 1.9 V to thereby suppress the overshoot phenomenon. This example is shown in FIG. 8. In FIG. 8, the response speed is improved without overshoot: the response time was shortened from 53 msec to 7.6 msec.

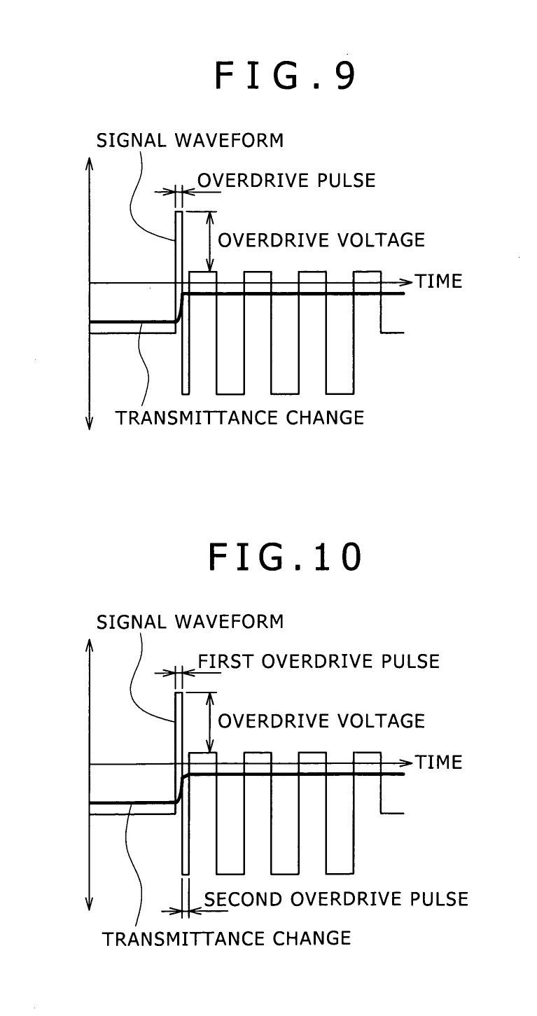

Next, the results of the overdrive driving of the present embodiment will be shown below. As Working example 1, the overdrive voltage was changed from 2.5 V of the related-art system to 3.8 V, and the overdrive pulse application period was changed from 16 msec of the related art to 4.8 msec. Thereby, the response speed could be improved to 2 msec without overshoot. The drive waveform and the transmittance response waveform of this example are shown in FIG. 9.

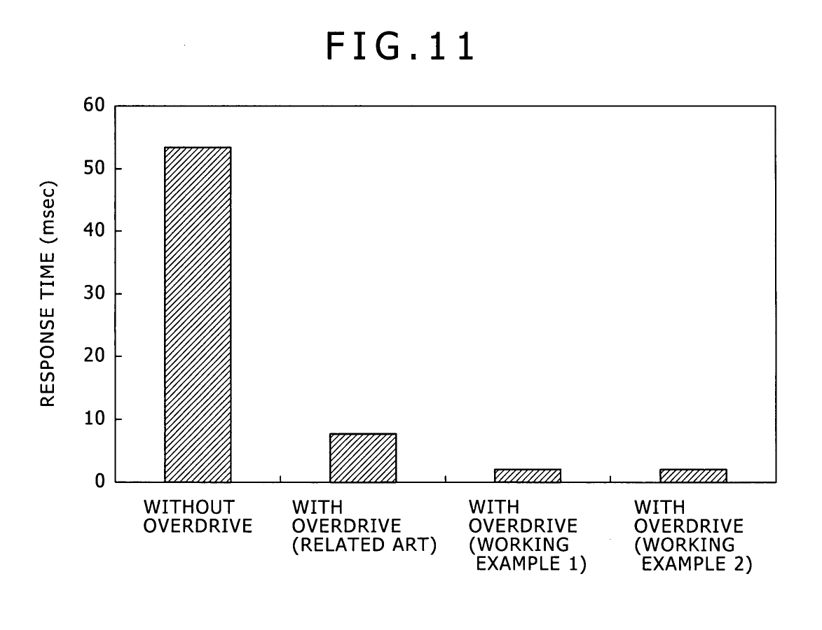

In Working example 2, as two overdrive voltages of different polarities, a first overdrive voltage of 3.9 V was applied for 4 msec and a second overdrive voltage (overdrive correction voltage) of 2 V was applied for 4 msec. Thereby, the response speed could be improved to 1.9 msec without overshoot similarly. The drive waveform and the transmittance response waveform of this example are shown in FIG. 10. FIG. 11 collectively shows the effects of the improvement in the response speed in the above-described experimental examples.

In this manner, a method of suppressing overshoot and undershoot through adjustment of the overdrive voltage is not employed, but the overdrive voltage is kept at constant and the application period of the overdrive voltage is adjusted to thereby suppress overshoot and undershoot. This allows improvement in the response speed on the lower-grayscale side particularly.

### <Application Examples>

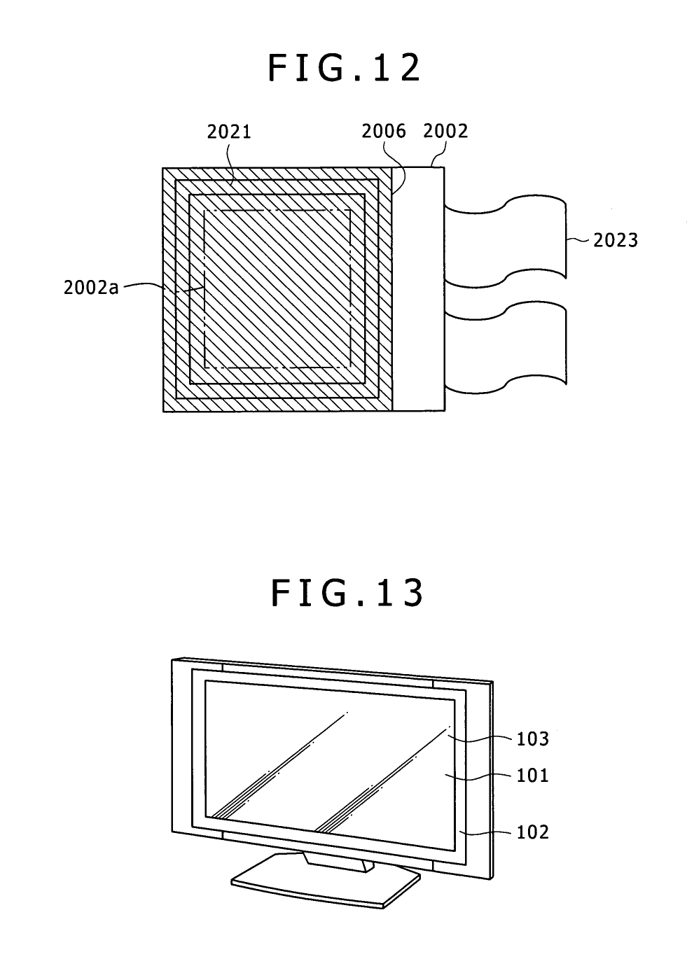

The liquid crystal display device according to the present embodiment encompasses also a module-shape device with a sealed structure like that shown in FIG. 12. For example, the display module shown in FIG. 12 is formed by providing a sealing part 2021 surrounding a display area 2002a as a pixel array part and bonding the display unit to a counter member (sealing substrate 2006) such as a transparent glass substrate by use of the sealing part 2021 as an adhesive.

This transparent sealing substrate 2006 may be provided with a color filer, protective film, light-shielding film, and so on. The substrate 2002 as the display module on which the display area 2002a is formed may be provided with a flexible printed board 2023 for external inputting/outputting of signals and so on to/from the display area 2002a (pixel array part).

### <Various Kinds of Electronic Apparatus>

The above-described liquid crystal display device according to the present embodiment can be applied to various kinds of electronic apparatus shown in FIGS. 13 to 17. Specifically, the liquid crystal display device can be used as a display device in electronic apparatus in any field that displays an image or video based on a video signal input to the electronic apparatus or produced in the electronic apparatus, such as a digital camera, notebook personal computer, portable terminal apparatus typified by a cellular phone, and video camera. Examples of electronic apparatus to which the present embodiment is applied will be described below.

FIG. 13 is a perspective view showing a television to which the present embodiment is applied. The television according to the present application example includes a video display screen 101 composed of a front panel 102, a filter glass 103, and so on, and is fabricated by using the liquid crystal display device according to the present embodiment as the video display screen 101.

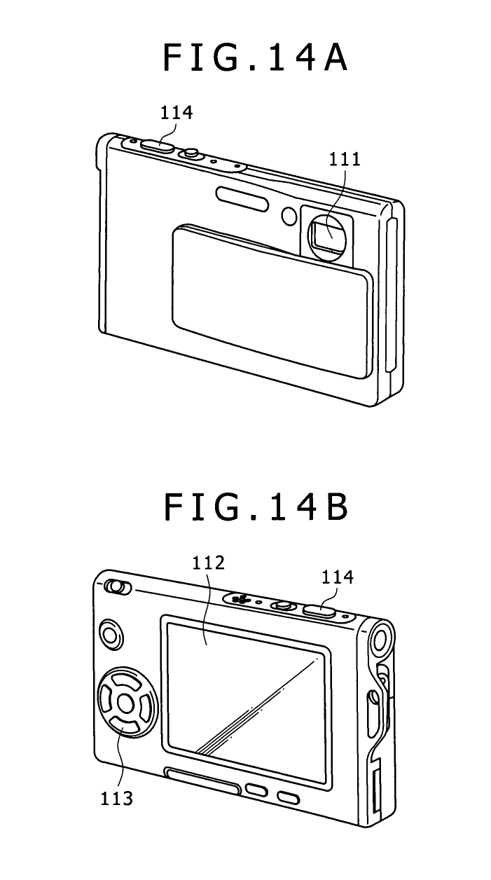

FIGS. 14A and 14B are perspective views showing a digital camera to which the present embodiment is applied: FIG. 14A is a front-side view and FIG. 14B is a rear-side view. The digital camera according to the present application example includes a light emitter 111 for flash, a display part 112, a menu switch 113, a shutter button 114, and so on, and is fabricated by using the liquid crystal display device according to the present embodiment as the display part 112.

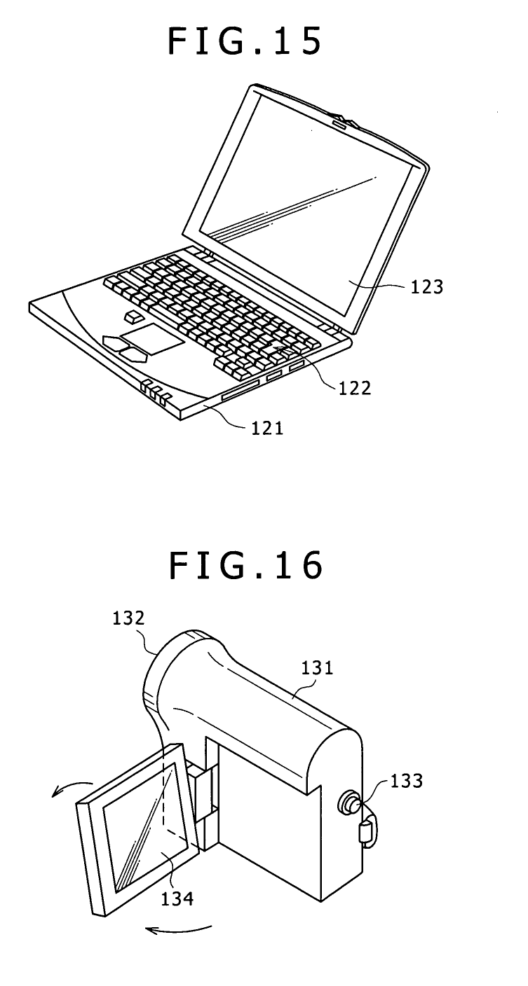

FIG. 15 is a perspective view showing a notebook personal computer to which the present embodiment is applied. The notebook personal computer according to the present application example includes in a main body 121 thereof a keyboard 122 operated in inputting of characters and so forth, a display part 123 for displaying images, and so on. This notebook personal computer is fabricated by using the liquid crystal display device according to the present embodiment as the display part 123.

FIG. 16 is a perspective view showing a video camera to which the present embodiment is applied. The video camera according to the present application example includes a main body 131, a lens 132 that is disposed on the front side of the camera and used to capture a subject image, a start/stop switch 133 for imaging operation, a display part 134, and so on. This video camera is fabricated by using the liquid crystal display device according to the present embodiment as the display part 134.

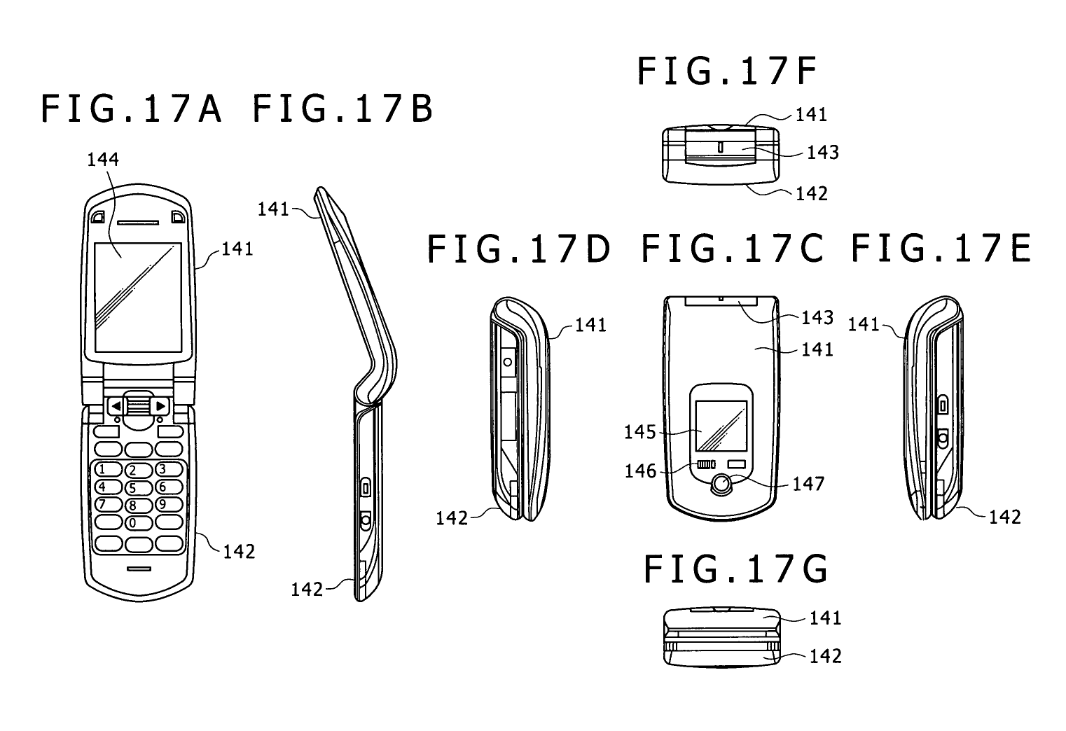

FIGS. 17A to 17G are diagrams showing a cellular phone as portable terminal apparatus to which the present embodiment is applied: FIGS. 17A and 17B are a front view and side view, respectively, of the opened state, and FIGS. 17C to 17G are a front view, left-side view, right-side view, top view, and bottom view, respectively, of the closed state. The cellular phone according to the present application example includes an upper casing 141, a lower casing 142, a connection (hinge) 143, a display 144, a sub-display 145, a picture light 146, a camera 147, and so on. This cellular phone is fabricated by using the liquid crystal display device according to the present embodiment as the display 144 and the sub-display 145.

It should be noted that the liquid crystal display device of the present embodiment can be applied also to products other than the above-described application examples.

It should be understood by those skilled in the art that various modifications, combinations, sub-combinations and alternations may occur depending on design requirements and other factors insofar as they are within the scope of the appended claims or the equivalent thereof.

What is claimed is:

1. A liquid crystal display device that carries out image displaying through application of a voltage dependent upon an image to a liquid crystal in units of a certain period, wherein
in the case of applying an overdrive voltage higher than a voltage for displaying of the image to the liquid crystal before application of the voltage, an application period of the overdrive voltage is set shorter than the certain period.

2. The liquid crystal display device according to claim 1, wherein
the application period of the overdrive voltage is adjusted depending on a grayscale level of the image.

3. The liquid crystal display device according to claim 1, wherein
the application period and a voltage value of the overdrive voltage are adjusted depending on a grayscale level of the image.

4. The liquid crystal display device according to claim 1, wherein
the overdrive voltage includes a first overdrive voltage and a second overdrive voltage that have different polarities.

5. A method for driving a liquid crystal display device that carries out image displaying through application of a voltage dependent upon an image to a liquid crystal in units of a certain period, the method comprising the step of
in the case of applying an overdrive voltage higher than a voltage for displaying of the image to the liquid crystal before application of the voltage, applying the overdrive voltage for an application period shorter than the certain period.

6. The method for driving a liquid crystal display device according to claim 5, wherein
the application period of the overdrive voltage is adjusted depending on a grayscale level of the image.

7. The method for driving a liquid crystal display device according to claim 5, wherein
the application period and a voltage value of the overdrive voltage are adjusted depending on a grayscale level of the image.

8. The method for driving a liquid crystal display device according to claim 5, wherein
the overdrive voltage includes a first overdrive voltage and a second overdrive voltage that have different polarities.

9. Electronic apparatus including a liquid crystal display device that carries out image displaying through application of a voltage dependent upon an image to a liquid crystal in units of a certain period, wherein
in the case of applying an overdrive voltage higher than a voltage for displaying of the image by the liquid crystal display device to the liquid crystal before application of the voltage, an application period of the overdrive voltage is set shorter than the certain period.
